(19) United States
(12) Patent Application Publication
(10) Pub. No.: US 2009/0234803 A1
(43) Pub. Date: Sep. 17, 2009

(54) KEYWORD SEARCH OF BUSINESS INFORMATION SYSTEM

(75) Inventors: John C. Greenwell, (US); Doug Wilson, (US)

Correspondence Address: LAW OFFICES OF EUGENE M. CUMMINGS, P.C., ONE NORTH WACKER DRIVE, SUITE 4130, CHICAGO, IL, 60606, US

(73) Assignee: Continental Electrical Construction Company, LLC

(21) Appl. No.: 12/046,188

(22) Filed: Mar. 11, 2008

(51) Int. Cl. G06F 17/30

(52) U.S. Cl. 707/3; 707/E17.001

(57) ABSTRACT

A building data monitoring software system with keyword search capability is disclosed. Different building data points are gathered by a monitoring computer, which generates reports. Metadata is associated with reports and data points that are to be user accessible. A user inputs a search string using a web browser or other input mechanism, and a list of search results, comprising data points and reports matching the search string are returned.

### FIELD OF THE INVENTION

The present invention relates generally to systems, apparatus, and methods for organizing and accessing building information systems data, and more particularly to systems, apparatus, and methods for organizing building information systems data to be accessible via an abstract search, systems, apparatus and methods of detecting building data points wholly or partially matching a formulated query, and systems, apparatus and methods for delivering building data points to end-users in a usable format.

### DESCRIPTION OF THE PRIOR ART

Building information systems are now widely used to monitor the numerous services and utilities employed by modern facilities. For example, facilities almost universally use electricity to provide light, power computers, and air conditioning, natural gas to provide heat, telephone lines to provide voice communications, data connections to provide Internet access, and numerous other utilities. In addition, many facilities now provide security services to occupants, such as tracking when particular occupants come and go through the use of a card access entrance or elevator, or restricting access to certain areas to a limited group of persons. All of these utilities and services produce data points, such as the instantaneous amount of natural gas that is being used, or the fact that a particular person has just “keyed-in” and is now in the building. Existing building information systems allow facility managers to monitor the various data points, as well as assemble useful reports, such as the average amount of electricity consumed on a daily basis, or between the hours of 7 AM and 6 PM on weekdays. Such reports can be used for operational planning, financial forecasting and other purposes.

While prior art building information systems are very useful to building managers, they tend to provide a piece meal approach, meaning that different systems are used to monitor different data generators, i.e., one system monitors the amount of electricity used, while a separate system monitors bandwidth usage, and yet another system monitors security systems. Accordingly, there is no simple way for a user to gather information about numerous different building systems. Instead, information must be gathered from the numerous disparate systems and amalgamated to provide an overview of the building.

### OBJECTS OF THE INVENTION

Accordingly, it is an object of this invention to provide a system, apparatus, and method enabling a user to easily locate and monitor one or more building data points describing a quantity that the user is interested in.

Another object of this invention is to provide a system, apparatus, and method enabling a user to search a building's combined information systems by keyword.

### SUMMARY OF THE INVENTION

The disclosed invention achieves its objectives by providing building data monitoring software that collects a plurality of data points from different building information systems, and, using those data points, compiles a plurality of reports. An operator then associates metadata with each report or data point that the system needs to make available to users. A user then inputs a search string or other search object using a user terminal, and the metadata associated with different data items is compared with the input search object. Where the metadata and the search object are sufficiently similar, the data item associated with the metadata is added to a search report, which is exported to the user terminal.

### BRIEF DESCRIPTION OF THE DRAWINGS

Although the characteristic features of this invention will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a network diagram of a computer information system constructed in accordance with an embodiment of the disclosed invention;

FIG. 2 is a block diagram depicting the relationship of a building data item and a collection of metadata describing the data item, as used in an embodiment of the disclosed invention;

FIG. 3 is sample energy usage report as produced by an embodiment of the disclosed invention;

FIG. 4A is a sample occupancy report as produced by an embodiment of the disclosed invention;

FIG. 4B is a sample temperature report as produced by an embodiment of the disclosed invention;

FIG. 5 is a screenshot depicting search results returned by a web-based embodiment of the disclosed invention;

FIG. 6 is a sample display of monitored data points as produced by an embodiment of the disclosed invention.

### DETAILED DESCRIPTION OF THE ILLUSTRATED EMBODIMENT

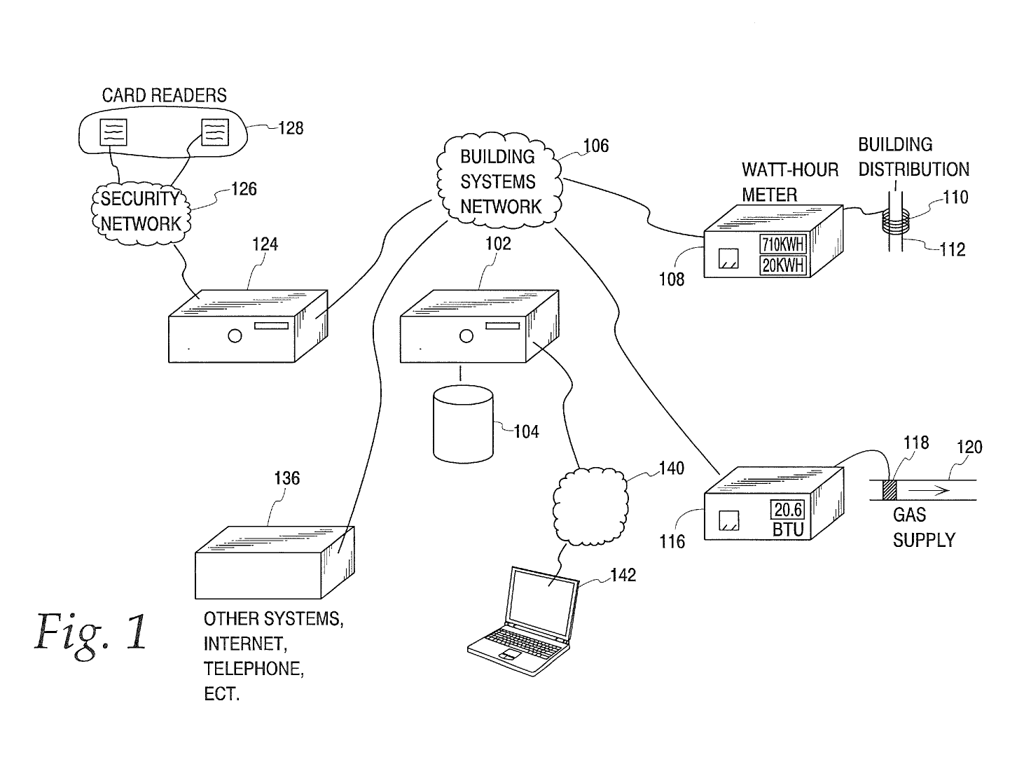

Turning to the Figures, and to FIG. 1 in particular, a building information system constructed in accordance with the disclosed invention is depicted. A data monitoring computer 102 is connected to other building information systems 108,116,124,136 through a building information systems network 106, which may be implemented using any networking technology. The data monitoring computer 102 utilizes storage 104 to hold various data points gathered from other building information systems 108,116,124,136 and reports compiled form the accumulated data points.

A typical facility will include a number of building information systems. FIG. 1 includes systems to monitor electricity and natural usage, as well a security system, and a catchall to represent other systems, such as data usage, and telephone line use. As depicted, a watt-hour meter 108 is coupled to a building's main power line 112 by a power monitoring device 110. The remainder of the building is powered by a connection to the building main 112, and accordingly, the power monitoring device 110 monitors the power usage by the entire building. In addition, a natural gas meter 116 monitors the building's main gas line 120 through a gas line monitor 118. FIG. 1 also depicts a security system 124, which receives data from a plurality of card readers 128 through a security network 126. Other systems are monitored by separate or combined building information systems 136. It should also be noted that the particular type of building information system monitored is not a limitation of this invention. For example, an electricity monitor comprised of a networked sensor without a separate metering machine would fall within the scope of this invention, as would a network of face detection cameras used instead of or in cooperation with a card reader network.

In typical operation, the data monitoring computer 102 will periodically query networked building information systems 108,116,124,136 to receive various monitored building data points, which will then be written to storage 104. Alternatively, the building information systems 108,116,124,136 could push data to the data monitoring computer 102. The data monitoring computer 102 will then use the accumulated data to generate some number of predefined reports, which are discussed in further detail below.

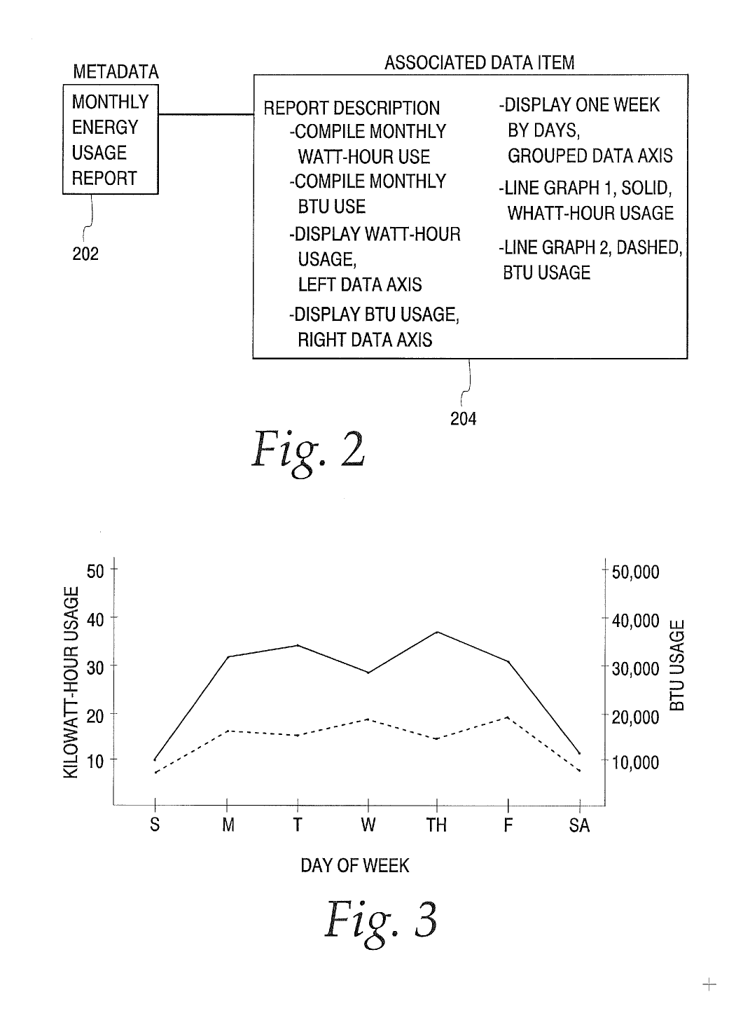

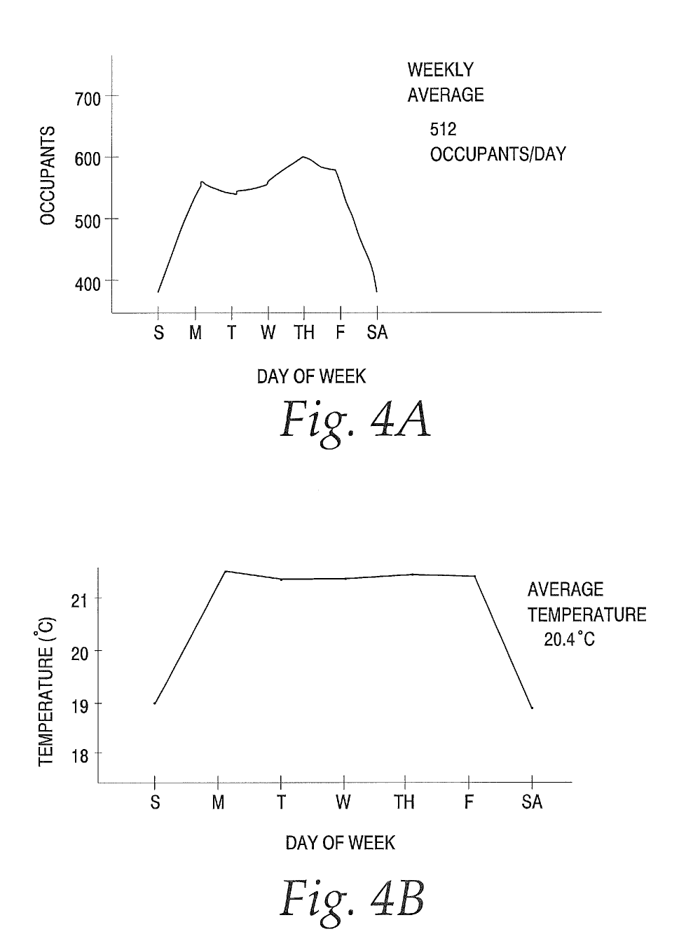

Turning to FIG. 2, a collection of metadata 202 is associated with a data item 204, such as a data point, or a report. In this case, the metadata 202 is a simple collection of terms, i.e., “monthly energy usage report.” However, using techniques known in the art, larger amounts of text, and even pictures could be used as metadata to describe a data item. The form of metadata is not a limitation of the invention. The data item 204 depicted in this case is a report on monthly energy usage. A modified energy usage report, only showing one week's worth of data, is depicted in FIG. 3, and FIG. 4A depicts a sample occupancy report, and FIG. 4B depicts a sample temperature report.

Returning to FIG. 1, a user terminal 142, such as a laptop computer with a web browser, is coupled to the data monitoring computer 102 by a network 140, such as the Internet, or a corporate intranet. A user will access reports and data points monitored by the data monitoring computer 102 through the user terminal 142. A user could also conceivably use the data monitoring computer 102 to access such reports and data points.

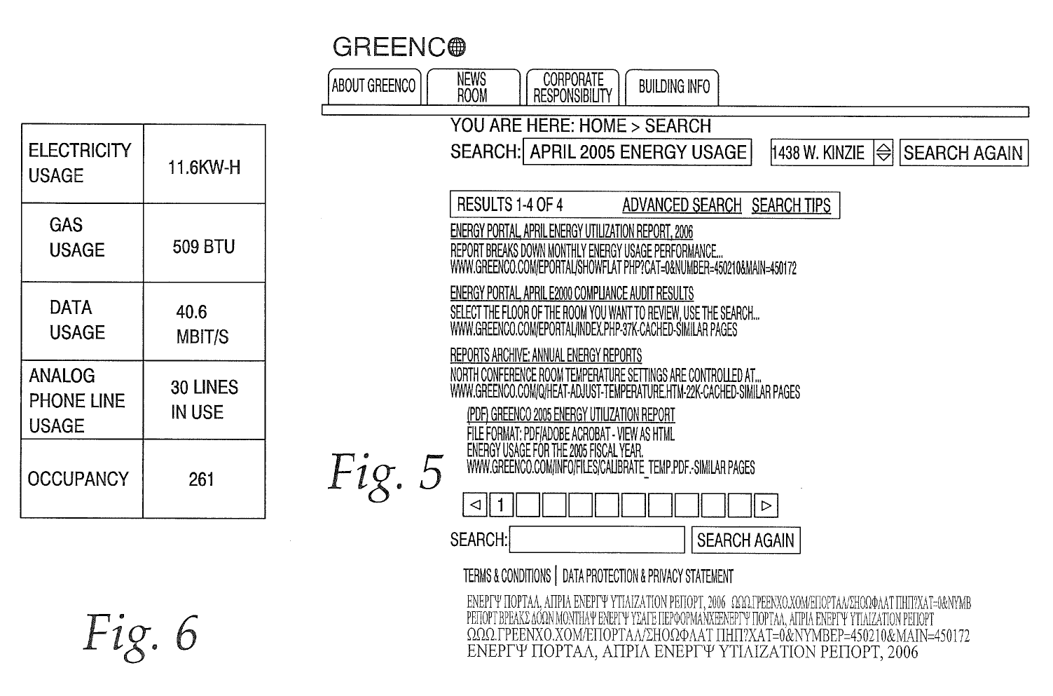

One way that the data monitoring computer 102 could make information available to user terminal 142 is through the use of a web page. This would require the data monitoring computer 102 to incorporate a web server, and the user terminal 142 to incorporate a browser. After accessing the building information web page exported by the data monitoring computer 102, a user could input a search string, or some other kind of search object. The input search object will then be matched against metadata associated with various data items stored by the data monitoring computer 102, and if the search object and metadata associated with a data item are sufficiently similar, the data item will be included in a set of search results returned to the user. Various methods well known in the prior art may be used to determine if a search object and metadata are sufficiently similar, and other methods also well known in the prior art may be used to rank the items in the search results. Finally, a set of search results is returned to the user. One sample set of search results returned in response to the search object “April 2005 Energy usage” is depicted in FIG. 5. When a particular search result is selected, the associated report is displayed, as depicted in FIGS. 3-4, or a collection of data points is displayed, as shown in FIG. 6. The data points may be static or updated in real time.

The foregoing description of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

What is claimed is:

1. A system for retrieving building information desired by a user, said system comprising:
i) a plurality of building information sensors for generating building data;
ii) a computer for receiving said building data, said computer further compiling at least one report based on said building data, and associating with said report a collection of metadata describing said report; and
iii) a user terminal communicatively coupled to said computer, said user terminal including an input device for entering a search object,
wherein said user terminal communicates said search object to said computer, and wherein said computer compares said search object to said metadata, and communicates data from said report to said user terminal if said search object is substantially similar to said metadata.

2. The system of claim 1, wherein said search object is one or more key words.
